(19) United States
(12) Patent Application Publication
(10) Pub. No.: US 2015/0286689 A1
(43) Pub. Date: Oct. 8, 2015

(54) Systems and Methods for Displaying Geographic Location Information Corresponding to Search Result

(71) Applicant: Google Inc., Mountain View, CA (US)

(72) Inventors: Jeremy Brand Sussman, Bedford Hills, NY (US); Jason Yuet Ming Lee, Middle Village, NY (US); Michelle Lee, Philadelphia, PA (US)

(73) Assignee: Google Inc., Mountain View, CA (US)

(21) Appl. No.: 13/705,271

(22) Filed: Dec. 5, 2012

(51) Int. Cl. G06F 17/30

(52) U.S. Cl. CPC G06F 17/30554

(57) ABSTRACT

Embodiments include a computer-implemented method that includes identifying a set of search results to be provided for display to a user via a search results listing, wherein two or more of the search results are associated with geographic locations, determining a smallest common region that includes at least a threshold amount of the geographic locations associated with the two or more search results, for each of the two or more search results, identifying a descriptor of a sub-region of the smallest common region that includes the geographic location associated with the search result, and providing the set of search results for display, each of the two or more search results to be displayed in association with the identified descriptor of the sub-region of the smallest common region that includes the geographic location associated with the search result.

### BACKGROUND OF THE INVENTION

1. Field of the Invention

Embodiments of this invention relate generally to search industries and, more particularly, to special purpose machines, systems, methods and computer instructions for displaying location information corresponding to search results.

2. Description of the Related Art

Persons employ Internet searches in an effort to locate items that interest them from the millions of items available on the Internet. For example, a user may submit a search for “New York City Restaurants” in hopes of locating webpages, maps, and the like that provide information regarding restaurants in New York City. Search results typically include a listing of hyperlinks to the location of relevant items on the Internet as well as some information about the search result. In the case of a search result corresponding to an entity having a geographic location, the search result is sometimes accompanied by a physical address for the entity.

Applicants have recognized that, in many instances, a user may not be able to readily identify locations corresponding to address information traditionally provided with search results. For example, a user may not be able to readily identify a location corresponding to an address of “1500 Broadway, New York, N.Y. 10036” where some addresses on Broadway are located in the Upper Westside of New York City while other addresses on Broadway are located in Times Square. Moreover, Applicants have recognized that in many instances presenting a physical address may be difficult or otherwise clutter the displayed results, especially on smaller display screens such as those of cell phones, PDAs, tablets, and the like.

### SUMMARY OF THE INVENTION

Various embodiments of methods and apparatus for displaying search results are provided herein. In some embodiments, provided is a computer-implemented method that includes identifying a set of search results to be provided for display to a user via a search results listing, two or more of the search results being associated with geographic locations, determining a smallest common region that includes at least a threshold amount of the geographic locations associated with the two or more search results, for each of the two or more search results, identifying a descriptor of a sub-region of the smallest common region that includes the geographic location associated with the search result, and providing the set of search results for display, each of the two or more search results to be displayed in association with the identified descriptor of the sub-region of the smallest common region that includes the geographic location associated with the search result.

In some embodiments, provided is a system including one or more memories storing instructions and one or more processors coupled to the one or more memories and executing the instructions stored thereon in order to perform the following steps: identifying a set of search results to be provided for display to a user via a search results listing, two or more of the search results being associated with geographic locations, determining a smallest common region that includes at least a threshold amount of the geographic locations associated with the two or more search results, for each of the two or more search results, identifying a descriptor of a sub-region of the smallest common region that includes the geographic location associated with the search result, and providing the set of search results for display, each of the two or more search results to be displayed in association with the identified descriptor of the sub-region of the smallest common region that includes the geographic location associated with the search result.

In some embodiments, provided is a computer-implemented method that includes receiving search result content and rendering the search result content for display. A resulting display including a listing of search result items, two or more of the search results each being displayed in associated with descriptors of a region that includes a geographic location corresponding to the search result, the region being a sub-region of a smallest common region that includes at least a threshold amount of the geographic locations associated with the two or more search results.

### BRIEF DESCRIPTION OF THE DRAWINGS

FIG. 1 is a flowchart that illustrates a method for displaying search results in accordance with one or more embodiments of the present invention.

FIG. 2 is a table that illustrates a set of search results in accordance with one or more embodiments of the present invention.

FIG. 3 is an illustration of a geographic map that illustrates geographic locations corresponding to the set of search results of FIG. 2 in accordance with one or more embodiments of the present invention.

FIG. 4 is an illustration of a webpage displaying map-based search results in accordance with one or more embodiments of the present invention.

FIG. 5 is a block diagram that illustrates a query environment in accordance with one or more embodiments of the present invention.

FIG. 6 is a block diagram that illustrates an exemplary computer system in accordance with one or more embodiments of the present invention.

### DETAILED DESCRIPTION

As discussed in more detail below, provided are embodiments of systems and methods for displaying geographic location information corresponding to search results. Certain embodiments of the invention include providing concise geographic location information in association with search results. The concise geographic location information can include the names of geographic regions (e.g., the name of a neighborhood, a city, a county, or the like) that are provided in-place of complete physical addresses that are typically provided with search results. For example, a search result for “New York Cafe” (a restaurant located at 1500 Broadway in Times Squares of New York City) may be accompanied by concise geographic location information specifying the region of “Times Square” as opposed to the physical address of “1500 Broadway, New York, N.Y. 10036”. It is expected that such concise geographic location information may be preferred by users as it allows them to quickly assess a geographic location associated with the search result without having to determine a geographic location that corresponds to a physical address. Further, it is expected that use of concise geographic location information may be particularly beneficial with smaller displays (e.g., displays of cell phones, PDAs, tablets, etc.) where display of a full address is not possible due to space constraints or display of the full address would clutter the display.

Concise geographic location information displayed can be determined based on geographic locations associated with search results. For example, where some or all of a set of search results to be displayed are associated with geographic locations, the concise geographic location can describe a sub-region of a common geographic region that includes at least a threshold amount of the geographic locations. The threshold amount can be defined by a given number, a given percentage, a majority, substantially all (e.g., greater than about 95%), all of the geographic locations or the like. The concise geographic location information displayed can include descriptors of regions (“sub-regions”) having a level of granularity that is one or more hierarchical levels lower than a level of the smallest common region that includes at least the threshold amount of the geographic locations. For example, where a set of ten search results to be displayed all fall within the city limits of New York City, the smallest common level may be identified as the “city” level, the next lower level of granularity may be identified as the “neighborhood” level, and, thus, each search result may be displayed in association with the name of their corresponding neighborhood (e.g., Times Square, Upper West Side, Upper East Side, Central Park, West Village, Bowling Green, etc.). The name of the neighborhoods may be displayed in-place of the physical addresses often displayed in association with search results.

Although concise geographic location information may be displayed in association with search results, the physical address or similar geographic location information may be readily available to the user. For example, upon hovering over the text of the concise location information (e.g., a name of a neighborhood), the physical address can be displayed in a pop-up bubble. As a further example, upon copying the text of the concise geographic location information, the physical address can be inserted upon the corresponding paste operation.

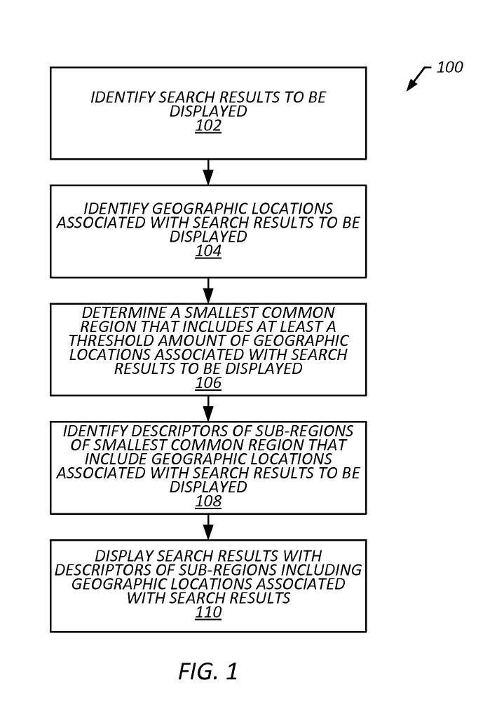

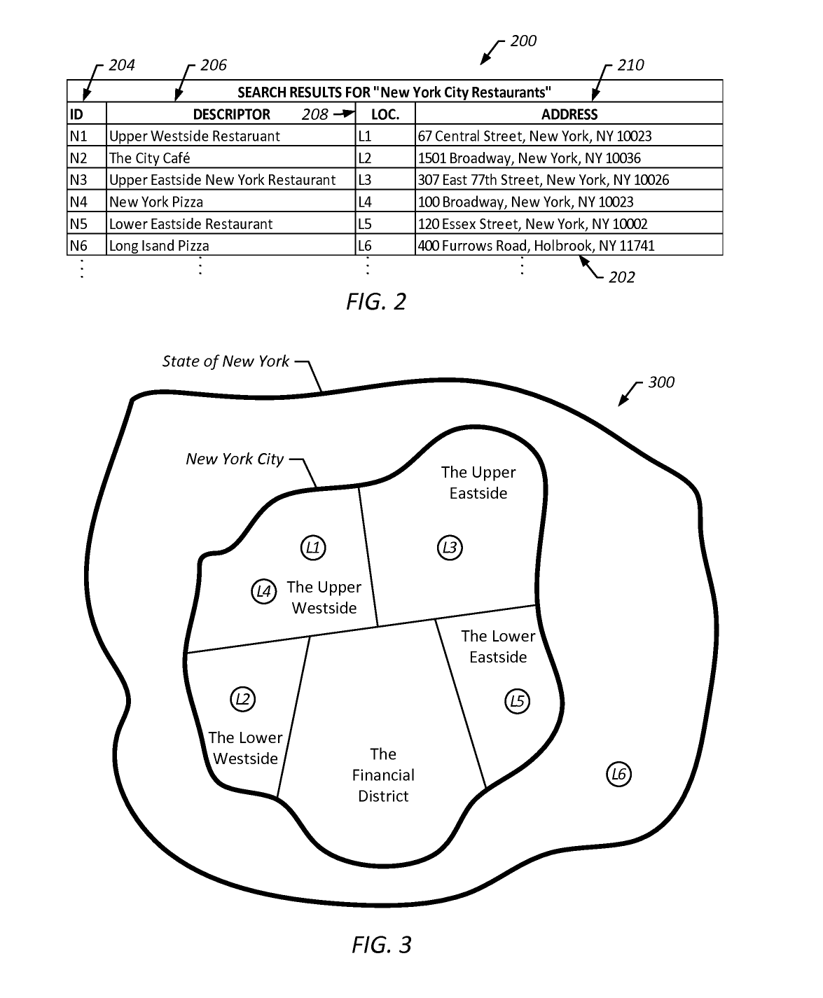

FIG. 1 is a flowchart that illustrates an exemplary method 100 for displaying search results. Method 100 includes identifying search results to be displayed, as depicted at block 102. Identifying search results to be displayed can include identifying a listing of search results that are to be displayed to a user. For example, where a user visits a search web page and submits a search query for “New City York Restaurants”, a corresponding search query is submitted to a search server (e.g., a search engine), and the search server processes the search query to identify a listing of search results (e.g., a listing of entities/webpages) corresponding to “New York City Restaurants”. FIG. 2 is a table 200 that illustrates an exemplary set of search results 202. Search results 202 includes a listing of search results identified by a search engine in response to the search query for “New York City Restaurants”. Each entry of table 200 corresponds to a given one of the search result of set of search results 202. Each entry includes an identifier 204, a descriptor 206, a location 208, and an address 210.

Identifier 204 may include a unique identifier that is used to distinguish a given entry from other entries/results. Descriptor 206 may include a name/title or other descriptive information associated with the corresponding entity. Location 208 may specify or otherwise be indicative of a geographic location associated with the corresponding entity. Location 208 may represent a set of geographic coordinates (e.g., longitude and latitude coordinates) corresponding to a geographic location of the corresponding entity. For example, the location “L1” can represent geographic coordinates corresponding to the geographic location of the address “67 Central Street, New York, N.Y. 10023”. Address 210 includes a physical address associated with the corresponding entity.

Identifying search results to be displayed may include identifying particular ones of the search results that will ultimately be displayed to the user. For example, where a web page only has enough room to display five search results, identifying search results to be displayed can includes identifying the five highest ranked search results of the listing of search results 202. Accordingly, where table 200 includes a ranked listing of search results 202, the search results for “Upper Westside Restaurant”, “The City Café”, “Upper Eastside New York Restaurant”, “New York Pizza” and “Lower Eastside Restaurant” may be identified as the search results to be displayed.

Method 100 includes identifying geographic locations associated with search results to be displayed, as depicted at block 104. Identifying geographic locations associated with search results to be displayed includes identifying locations 208 corresponding to the search results. For example, where the five highest ranked search results of the listing of search results 202 are to be displayed (i.e., the sixth result for “Long Island Pizza” is not a search result returned for display), identifying geographic locations associated with search results to be displayed includes identifying the locations “L1”, “L2”, “L3”, “L4” and “L5” which correspond to the five highest ranked results. Where a given search result is not associated with a location, no location may be identified for that search result. For example, where one of the five results were to include a link to a webpage article, no location may be specified or identified for the search result and, thus, identifying geographic locations associated with search results to be displayed includes identifying only four locations.

Method 100 includes determining a smallest common region that includes at least a threshold amount of geographic locations associated with search results to be displayed, as depicted at block 106.

Regions may include any variety of geographic regions such as continents, countries, states, counties, cities/towns, postal-codes, neighborhoods, boroughs, or the like. These regions can include various sizes and hierarchical relationships. For example, a city region of a first hierarchical level may contain a plurality of neighborhood regions one level lower in the hierarchy. A region at a lower level than another region is referred to as a sub-region of the other region. An exemplary hierarchy of regions includes—from a highest/largest level to lowest/smallest level—continent, country, state, county, city/town, postal-code, and neighborhood.

Determining a smallest common region that includes at least a threshold amount of geographic locations associated with search results to be displayed may include determining a region of the lowest-level that includes at least a given number of, at least a given percentage of, at least a majority of, or all of the geographic locations associated with search results to be displayed. For example, where the threshold amount is a majority, a smallest common region includes a region of the lowest-level that includes greater than 50% (e.g., three or more) of the identified geographic locations “L1”, “L2”, “L3”, “L4” and “L5”.

FIG. 3 is an illustration of a geographic map 300 that illustrates geographic locations “L1”, “L2”, “L3”, “L4”, “L5” and “L6” corresponding to the set of search results 202 of FIG. 2. Where the threshold amount is all of the locations associated with the search results to be displayed, the smallest common region includes the region labeled “New York City” based on its boundary encompassing all five of the locations “L1”, “L2”, “L3”, “L4” and “L5” associated with the search results to be displayed. Notably, where the region labeled “The State of New York” corresponds to a level (e.g., a state level) that is higher than the level (e.g., city level) corresponding to the region labeled “New York City”, the region labeled “The State of New York” is not the smallest common region as it is at a higher level than another region (e.g., New York City) that includes all of the locations.

Method 100 includes identifying descriptors of sub-regions of the smallest common region that include locations associated with the search results to be displayed, as depicted at block 108. Where the smallest common region is identified as “New York City” having a city level, descriptors of sub-regions at the neighborhood level (i.e., one level below the city level) that include one or more of the locations are identified. For example, the neighborhood descriptors of “The Upper Westside”, “The Upper Eastside”, “The Lower Westside” and “The Lower Eastside” are identified based on each of the neighborhoods including at least one of the locations“L1”, “L2”, “L3”, “L4” and “L5” associated with the search results to be displayed.

Method 100 includes displaying search results with descriptors of sub-regions including geographic locations associated with search results, as depicted at block 110. Displaying search results with descriptors of sub-regions including geographic locations associated with the search results may include, for each search result displayed, displaying a descriptor that includes the geographic location corresponding to the search result as identified at block 108.

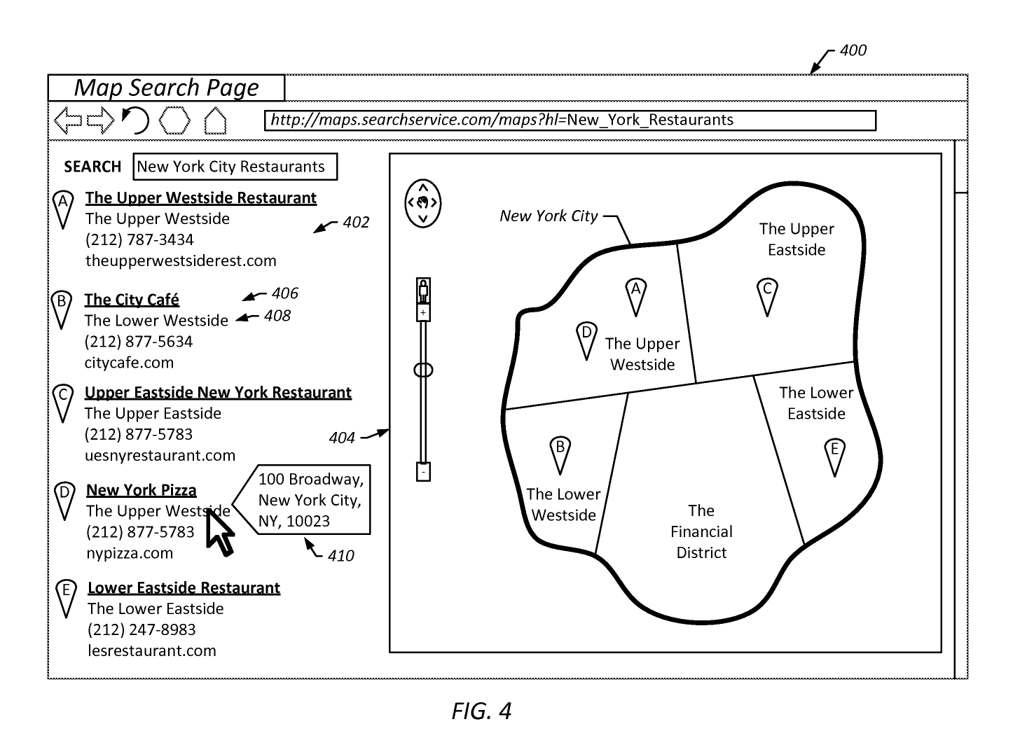

FIG. 4 is an illustration of an exemplary webpage 400 displaying map-based search results. Webpage 400 includes display of a listing of search results 402 and a map 404. Webpage 400 may be generated and served for display to a user, for example via an Internet web browser of a user's computer. Search results 402 correspond to the search results identified at block 102. Search results 402 include a concise geographic location descriptor 406 corresponding to a sub-region of the smallest common region that includes the location corresponding to the search result. For example based on “New York City” being identified as the smallest common region and location “L2” being located in “The Lower Westside”, the search result for “The City Café” includes the concise geographic location descriptor of “The Lower Westside”. Search results 402 may also include other information about the corresponding entity. For example, a search result 402 for “The City Café” includes a hyperlink that can be selected to navigate to a webpage corresponding to a home page for “The City Café”, other contact information (e.g., phone number), or the like. Similar concise location descriptors can be provided for some or all of other search results associated with a geographic location. Map 404 includes a geographic mapping of the smallest common region (e.g., New York City) and the corresponding sub-regions (e.g., “The Upper Westside”, “The Upper Eastside”, “The Lower Westside” and “The Lower Eastside”).

In some embodiments, where all of the results are in the same lowest level region (e.g., all in the same neighborhood), additional location information can be provided to further distinguish their locations. For example, where all search results are located in the Lower Westside, the descriptors may include the address and a cross-street (e.g., the search result for “The City Café” may be displayed in association with the descriptor of “1501 Broadway @ 43^{rd} St.”). Thus, a user can determine relative locations of results within the neighborhood or similar lowest level region.

Although concise geographic location information is displayed in association with search results, the addresses or similar geographic location information may be readily available to the user. For example, upon a user hovering a cursor over (or otherwise selecting) the text of the concise location information “The Upper Westside” of the search result for “New York Pizza”, the corresponding physical address “100 Broadway, New York City, N.Y., 10023” may be displayed in a pop-up bubble 410. As a further example, upon a user selecting to copy the text “The Upper Westside” of the concise geographic location information, the physical address of “100 Broadway, New York City, N.Y., 10023” may be provided upon the corresponding paste operation.

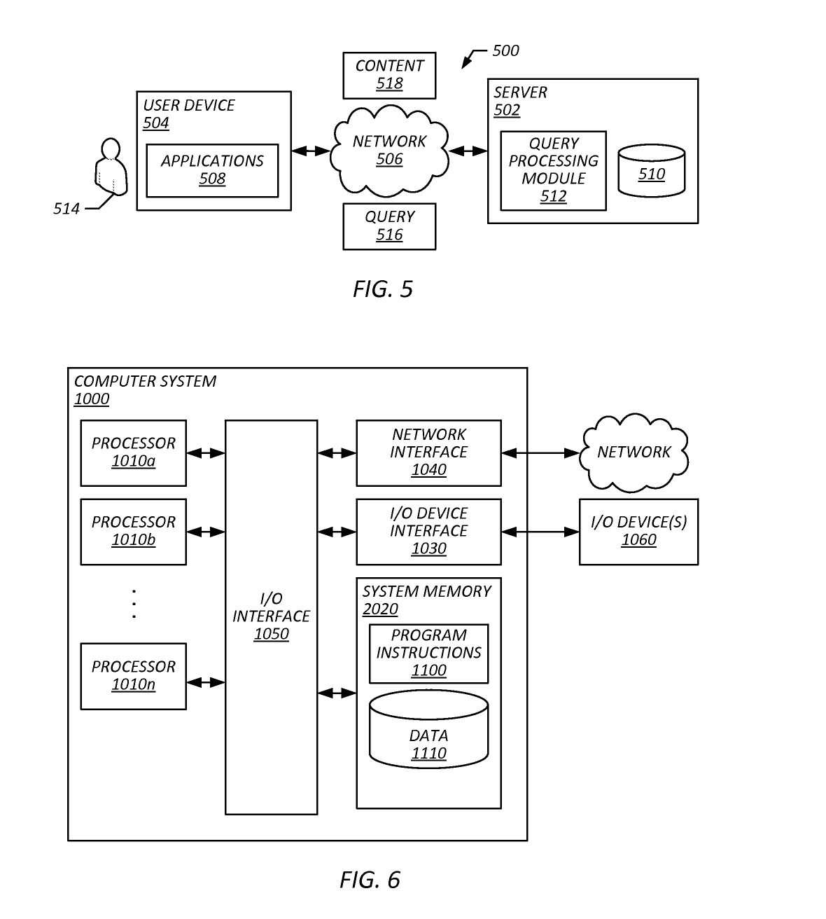

Methods 100 is an exemplary embodiment of methods that may be employed in accordance with techniques described herein. Method 100 may be may be modified to facilitate variations of its implementations and uses. Method 100 may be implemented in software, hardware, or a combination thereof. Some or all of method 100 may be implemented by one or more of the modules/applications described herein, such as query processing module 512 or application 508 depicted and described in more detail below with regard to FIG. 5. The order of method 100 may be changed, and various elements may be added, reordered, combined, omitted, modified, etc.

FIG. 5 is a block diagram that illustrates an exemplary query environment 500. Environment 500 includes a server 502 and an access device 504 communicatively coupled via a network 506.

Network 506 may include an electronic communications network, such as the Internet, a local area network (LAN), a wide area (WAN), a cellular communications network or the like. In some embodiments, network 506 may include a single network or combination of networks.

Access device 504 may include a device capable of communicating information via network 506. For example, access device 504 may include a personal computer (e.g., a desktop computer), a mobile computing device (e.g., a laptop or tablet computer), a cellular communication device (e.g., a cellular phone), a personal digital assistant (PDA), or the like. In some embodiments, access device 504 may be client device of server 502. In some embodiments, access device 504 may include various input/output (I/O) interfaces, such as a graphical user interface (e.g., display screen), an audible output user interface (e.g., speaker), an audible input user interface (e.g., microphone), a keyboard, a pointer/selection device (e.g., mouse, trackball, touchpad, touchscreen, stylus or the like), a printer, or the like. In some embodiments, access device 504 may include general computing components and/or embedded systems optimized with specific components for performing specific tasks. In some embodiments, access device 504 may include a computer system similar to that of computer system 1000 described below with regard to at least FIG. 6.

In some embodiments, access device 504 includes programs/applications 508 that can be used to generate a request for content, to provide content, to render content, and/or to send/receive request to/from other devices via network 506, such as client applications used for communicating with server 502. For example, access device 504 may include Internet browser application that facilitates communication with server 502 and/or other entities of environment 500. In some embodiments, application 508 includes modules having program instructions that are executable by a computer system to perform some or all of the functionality described herein with regard to access device 504.

Server 502 may include a network entity that serves requests by client entities, such as requests by access device 504. Server 502 may host a content site, such as a website, a file transfer protocol (FTP) site, an Internet search website or other source of network content. In some embodiments, server 502 includes a search engine. In some embodiments, server 502 includes or otherwise has access to a datastore 510, such as a database or similar data repository. In some embodiments, server 502 includes a query processing module 512. Query processing module 512 may include program instructions that are executable by a computer system to perform some or all of the functionality described herein with regard to server 502. In some embodiments, server 502 includes a computer system similar to that of computer system 1000 described below with regard to at least FIG. 6. Although server 502 is represented by a single box in FIG. 5, server 502 may include a single server or similar system, or a plurality of servers and/or similar systems. For example, server 502 may include a plurality of different servers and/or similar systems that may be employed individually or in combination to perform some or all of the functionality described herein with regard to server 502.

In some embodiments environment 500 is used to employ techniques described herein. For example, a user 514 may submit a query 516 (e.g., a keyword or map-based search query for “New York City Restaurants”) via access device 504, server 502 may process the query and serve content 518 (e.g., a search results webpage) to access device 504, and application 508 may render content 518 for display to user 514. In some embodiments, some or all of the processing of query 516 is provided by access device 504 and/or query processing module 512. For example, application 508 and/or query processing module 512 executes some or all of the processing described with regard to at least method 100.

Exemplary Computer System

FIG. 6 is a block diagram that illustrates an exemplary computer system 1000. Various portions of systems and methods described herein, may include or be executed on one or more computer systems similar to system1. For example, server 502 and/or access device 504 may include a configuration similar to at least a portion of computer system 1000. Further, methods/processes/modules described herein (e.g., query processing module 512 and/or application 508) may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof, or the like. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium having program instructions stored thereon that are executable by a computer processor (e.g., one or more of processors 1010a-1010n) to cause some or all of the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 3020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1. A computer-implemented method comprising:
identifying a set of search results to be provided for display to a user via a search results listing, two or more of the search results being associated with geographic locations;
determining a smallest common region that includes at least a threshold amount of the geographic locations associated with the two or more search results, wherein the smallest common region is determined, at least in part, by selecting a lowest hierarchical level of a hierarchy of publicly-recognized regions that satisfies the threshold, the hierarchy of publicly-recognized regions including at least three levels collectively corresponding to at least three of the following: continent, country, state, county, city, borough, and neighborhood;
for each of the two or more search results, identifying a descriptor of a sub-region of the smallest common region that includes the geographic location associated with the search result, wherein the descriptors of the sub-regions correspond to publicly-recognized names of at least one of the following: states, counties, cities, boroughs, and neighborhoods; and
providing the set of search results for display, each of the two or more search results configured to be displayed in association with the publicly-recognized name of the sub-region of the smallest common region that includes the geographic location associated with the search result and corresponds to the selected level of the hierarchy of publicly-recognized regions.

2. The method of claim 1, wherein determining a smallest common region that includes at least a threshold amount of the locations associated with the two or more search results comprises determining a smallest common region that includes at least a given percentage of the geographic locations associated with the two or more search results.

3. The method of claim 1, wherein determining a smallest common region that includes at least a threshold amount of the locations associated with the two or more search results comprises determining a smallest common region that includes at least a majority of the geographic locations associated with the two or more search results.

4. The method of claim 1, wherein determining a smallest common region that includes at least a threshold amount of the locations associated with the two or more search results comprises determining a smallest common region that includes all of the geographic locations associated with the two or more search results.

5. The method of claim 1, wherein the sub-region is one hierarchical level below the smallest common region.

6. The method of claim 1, wherein the smallest common region is at a city level of the hierarchy of publicly-recognized regions.

7. The method of claim 6, wherein the sub-region is at a neighborhood level of the hierarchy of publicly-recognized regions.

8. A system comprising:
one or more memories storing instructions; and
one or more processors coupled to the one or more memories and executing the instructions stored thereon in order to perform the following steps:
identifying a set of search results to be provided for display to a user via a search results listing, two or more of the search results being associated with geographic locations;
determining a smallest common region that includes at least a threshold amount of the geographic locations associated with the two or more search results, wherein the smallest common region is determined, at least in part, by selecting a lowest-level hierarchical level of a hierarchy of publicly-recognized regions that satisfies the threshold, the hierarchy of publicly-recognized regions including at least three levels collectively corresponding to at least three of the following: continent, country, state, county, city, borough, and neighborhood;
for each of the two or more search results, identifying a descriptor of a sub-region of the smallest common region that includes the geographic location associated with the search result, wherein the descriptors of the sub-regions correspond to publicly-recognized names of at least one of the following: states, counties, cities, boroughs, and neighborhoods; and
providing the set of search results for display, each of the two or more search results configured to be displayed in association with the publicly-recognized name of the sub-region of the smallest common region that includes the geographic location associated with the search result and corresponds to the selected level of the hierarchy of publicly-recognized regions.

9. The system of claim 8, wherein determining a smallest common region that includes at least a threshold amount of the geographic locations associated with the two or more search results comprises determining a smallest common region that includes at least a given percentage of the geographic locations associated with the two or more search results.

10. The system of claim 8, wherein determining a smallest common region that includes at least a threshold amount of the geographic locations associated with the two or more search results comprises determining a smallest common region that includes at least a majority of the geographic locations associated with the two or more search results.

11. The system of claim 8, wherein determining a smallest common region that includes at least a threshold amount of the geographic locations associated with the two or more search results comprises determining a smallest common region that includes all of the geographic locations associated with the two or more search results.

12. The system of claim 8, wherein the sub-region is one level below the smallest common region.

13. The system of claim 8, wherein the smallest common region is at a city level of the hierarchy of publicly-recognized regions.

14. The system of claim 8, wherein the sub-region is at a neighborhood level of the hierarchy of publicly-recognized regions.

15. A method of displaying search results, comprising:
receiving search result content;
generating instructions to display the search result content, the instructions being configured to cause a user device to render the search result content for display, a resulting display comprising a listing of search result items, two or more of the search results each being displayed in association with names of a publicly-recognized region that includes a geographic location corresponding to the search result, the region being a sub-region of a smallest common publicly-recognized region that includes at least a threshold amount of the geographic locations associated with the two or more search results; and
sending the instructions to a user device.

16. The method of claim 15, further comprising displaying a geographic mapping of at least the smallest common publicly-recognized region.

17. The method of claim 16, wherein the geographic mapping comprises markers at geographic locations corresponding to the two or more search results.

18. The method of claim 15, further comprising:
determining that there has been user interaction with a descriptor of a region corresponding to a search result; and
in response to determining that there has been user interaction with a descriptor of a region corresponding to a search result, displaying a physical address corresponding to the search result.

19. The method of claim 15, further comprising:
receiving a request to copy content of a descriptor of a region corresponding to a search result;
receiving a request to paste content of the content of descriptor of a region corresponding to the search result; and
in response to receiving a request to paste content of the content of descriptor of a region corresponding to the search result, pasting a physical address corresponding to the search result.

20. The method of claim 15, wherein the threshold amount of the geographic locations associated with the two or more search results comprises a given percentage, a majority or all of the geographic locations associated with the two or more search results.
